(19) United States
(12) Patent Application Publication
(10) Pub. No.: US 2018/0203790 A1
(43) Pub. Date: Jul. 19, 2018

(54) DETECTION OF SOFTWARE ERRORS

(71) Applicant: International Business Machines Corporation, Armonk, NY (US)

(72) Inventors: James E. Carey, Rochester, MN (US); Jim C. Chen, Rochester, MN (US); John M. Santosuosso, Rochester, MN (US)

(21) Appl. No.: 15/719,681

(22) Filed: Sep. 29, 2017

Related U.S. Application Data
(63) Continuation of application No. 15/407,275, filed on Jan. 17, 2017.

(51) Int. Cl. G06F 11/36

(52) U.S. Cl. CPC G06F 11/3636; G06F 11/3632

(57) ABSTRACT

A method, executed by a computer, includes repeatedly collecting execution information for a code unit to produce collected execution information for the code unit, generating an execution profile for the code unit based on the collected execution information, comparing current execution information for the code unit with the execution profile, and informing a user if the current execution information does not conform to the execution profile. A computer system and computer program product corresponding to the above method are also disclosed herein.

### BACKGROUND

The present invention relates generally to the field of software development, and more particularly to software debugging.

According to Wikipedia, debugging is the process of finding and resolving of defects that prevent the correct operation of computer software or a computer system.

### SUMMARY

A method, executed by a computer, includes repeatedly collecting execution information for a code unit to produce collected execution information for the code unit, generating an execution profile for the code unit based on the collected execution information, comparing current execution information for the code unit with the execution profile, and informing a user if the current execution information does not conform to the execution profile. A computer system and computer program product corresponding to the above method are also disclosed herein.

### BRIEF DESCRIPTION OF THE DRAWINGS

FIG. 1 is a screen shot depicting one example of an integrated debugging environment (IDE) in accordance with at least one embodiment disclosed herein;

FIG. 2 is a flowchart depicting one example of a software error discovery method in accordance with at least one embodiment disclosed herein;

FIGS. 3A and 3B are pseudo-code diagrams depicting an example of a use case in accordance with at least one embodiment of the present invention;

FIG. 4 is a user interface diagram depicting one example of a parameter limits interface in accordance with at least one embodiment of the present invention;

FIG. 5 is a block diagram depicting one example of a computing apparatus (e.g., cloud computing node) suitable for executing the methods disclosed herein;

FIG. 6 depicts a cloud computing environment in accordance with to at least one embodiment of the present invention; and

FIG. 7 depicts abstraction model layers in accordance with at least one embodiment of the present invention.

### DETAILED DESCRIPTION

The embodiments disclosed herein recognize that software development tools may present call stack info or other debugging information when a program crashes or generates an exception. While the call stack info and other debugging information may capture the effect of a bug, the cause of the program crash may not be discernable from the conveyed information. For example, many bugs are side effects of previous errors.

The embodiments disclosed herein also recognize that with currently available software development tools, manual analysis and isolation is typically required when finding the cause of a bug.

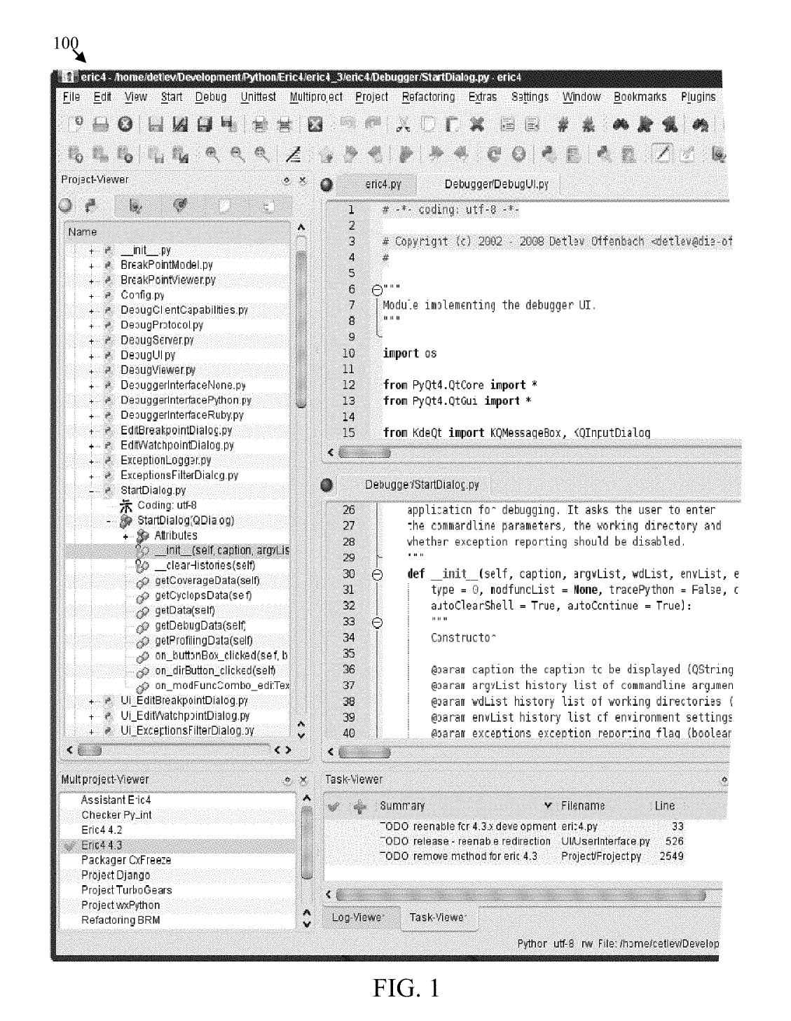

FIG. 1 is a screen shot depicting one example of an integrated development environment (IDE) 100 in accordance with at least one embodiment disclosed herein. As depicted, the IDE 100 provides a variety of interface panels 110 that facilitate the execution, examination, and modification (i.e., debugging) of software modules. One issue related to IDE's and other software debugging environments is that lines of code and the associated processing states are manually inspected and that the number of lines of code involved for many applications is too numerous and time consuming for manual inspection.

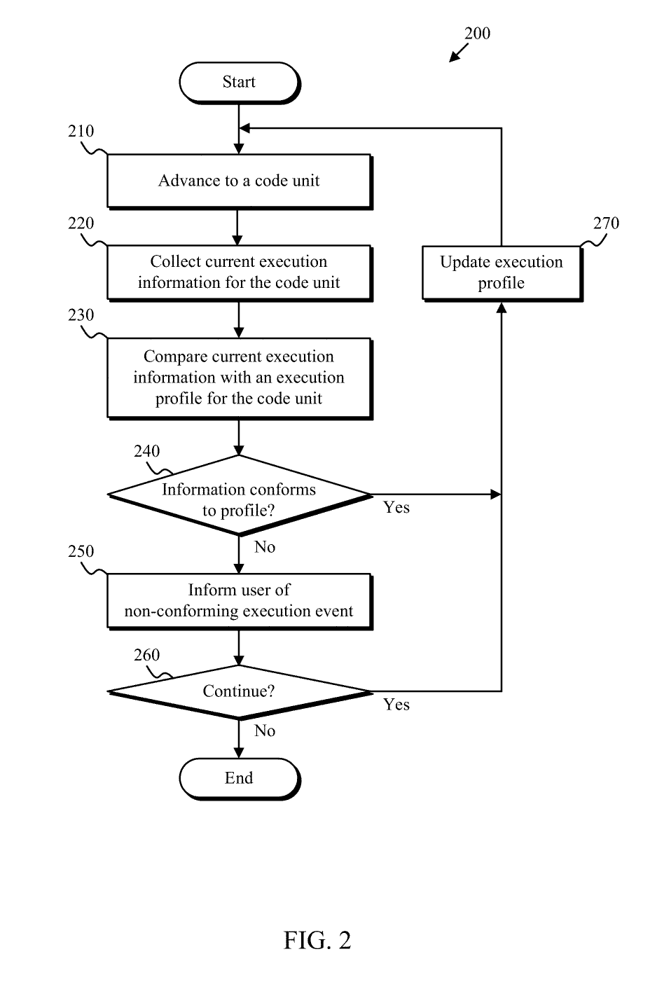

FIG. 2 is a flowchart depicting one example of a software error (i.e., “bug”) discovery method 200 in accordance with at least one embodiment disclosed herein. As depicted, the software error discovery method 200 includes advancing (210) to a code unit, collecting (220) current execution information, comparing (230) with an execution profile, determining (240) whether the current information conforms to the execution profile, informing (250) a user, determining (260) whether to continue, and updating (270) the execution profile. The software error discovery method 200 enables automatic or semi-automatic detection of potential software errors.

Advancing (210) to a code unit may include executing one or more software modules until a particular code unit is executed, or is about to be executed. Examples of code units include code statements, code blocks, subroutines, and function calls. Examples of code statements include wait statements, timer statements, IO statements, operating system calls, retry statements, exception statements, loop control statements, and branch statements.

In some embodiments, a ‘silent’ breakpoint is set at, within, or after, the desired code unit and an interrupt handler is invoked when the code unit is executed, or is about to be executed. The interrupt handler may execute some or all of the subsequent operations depicted in FIG. 2.

Collecting (220) current execution information may include collecting execution related information such as the value of various variables, call stack information, and other state information for one or more processors such as register values and branching information. Examples of branching information include a branching target and a branching source. The current execution information can also include metadata such as an execution duration or an execution count.

Comparing (230) with an execution profile may include comparing the current execution information with an execution profile. In some embodiments, the execution profile comprises statistical information such as distribution information or minimum and maximum (expected or allowed) values for specific variables. In certain embodiments, users may specify acceptable limits for the execution information.

Determining (240) whether the current information conforms to the execution profile may include determining whether each component of the current execution information fits within an expected or required range. If the current information does not conform to the execution profile the method continues by informing (250) a user. If the current information conforms to the execution profile, the method proceeds to updating (270) the execution profile for the code unit.

Informing (250) a user may include sending a message or displaying content that includes the current execution information. For example, the content may be displayed in and IDE or the like. In some embodiments, information from the execution profile for the code unit is also displayed. In one embodiment, informing a user includes suspending execution at a statement corresponding to the code unit and displaying state information for the suspended code and associated processor(s).

Determining (260) whether to continue may include determining whether a debugging session has ended. If the debugging session has ended, the method terminates. If the debugging session has not ended, the method proceeds to updating (270) the execution profile for the code unit. Updating (270) the execution profile may include updating the execution profile for the code unit based on the collected execution information.

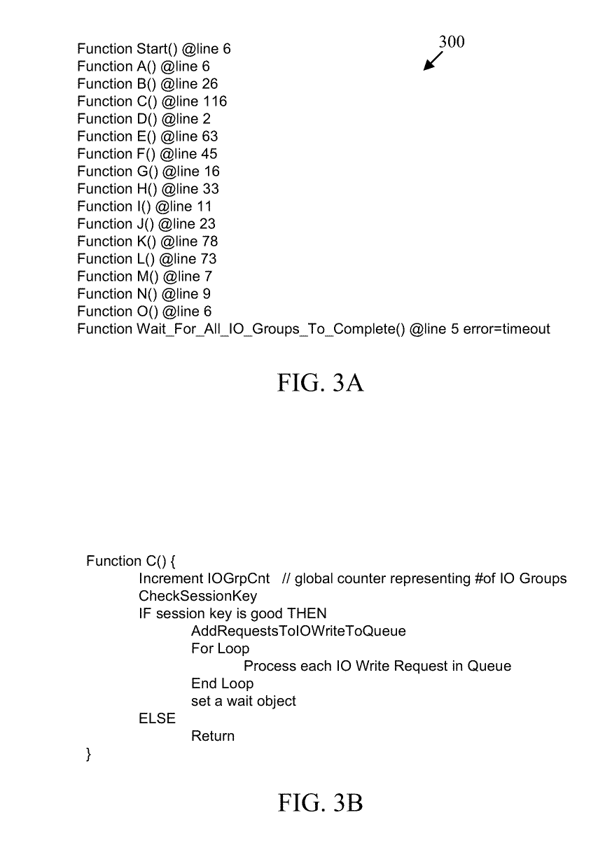

FIGS. 3A and 3B are pseudo-code diagrams depicting a use case in accordance with at least one embodiment of the present invention. FIG. 3A depicts a call stack 300 that shows the hierarchy of functions that have been called when an error occurs. One issue related to call stacks is that the error may be a side effect of a previously called function. Consequently, the faulty function and code statement may not be listed in the call stack. Identifying the offending function and code statement may be extremely difficult in that millions of code statements may have been executed previous to the error occurring.

For example, in the depicted scenario there may be many areas of code that initiate groups of IO write requests. Often such requests are associated with looping as is shown with Function C( ) in FIG. 3B. In such a situation, a global counter (e.g., IOGrpCnt) may be used to track the IO requests. Since write operations are typically asynchronous a function such as Function C( ) may initiate in IO request and simply move on. A wait object may be instantiated that waits for one or more IO write completion events. In the depicted example, the function Wait_For_All_IO_Groups_To_Complete( ) shown in FIG. 3A queries the global counter IOGrpCnt to determine the total number of IO groups with pending operations and then waits for all wait objects to signal completion.

Assuming, for the depicted scenario, that 30 IO requests are generated by 30 regions of code, the global counter IOGrpCnt would be expected to be 30. Consequently, 30 wait objects would be expected to report when their IO Writes have completed. In the depicted scenario, the call stack indicates that the function “Wait_For_All_IO_Groups_To_Complete” failed at line 5 due to timeout error. In this scenario, the examination of the call stack shows nothing conclusive of the root cause of the failure. All we know is that the system eventually timed out waiting for all of the IO requests to complete, but in this case at least one IO request group did not finish during the required timeout interval.

One of skill in the art will appreciate that each region of code may sequentially generate many IO requests. For example, as shown in FIG. 3B Function C( ) may typically process 15,000 sequential IO requests over an interval of 120 seconds. However, an unexpected error such as a bad session key could result in a premature exit. Due to faulty error handling, such a premature exit could result in a mismatch between the number of the pending IO requests and the global counter IOGrpCnt that tracks such requests. In such a scenario (depicted in FIGS. 3A and 3B) the function Wait_For_All_IO_Groups_To_Complete( ) could be waiting for a non-existent IO completion event either indefinitely or until a timeout event occurs.

The present invention addresses the above scenario by profiling all runs of the code to realize that function C( )'s loop usually requires 120 seconds of real processing time as well as knowing that the session key is usually good and the IF part of the IF-ELSE test shown in FIG. 3B is nearly always executed. A monitoring process may place an implicit breakpoint at the beginning of the loop as well as in the IF-ELSE branch and at the very end of the function. These would be regions of interest for code profiling. Depending on the user specified preferences of notification and thresholds to be notified at, the invention could have notified the user at any of the three implicit breakpoints due to their outlier behavior, namely: 1) break when we reach the ELSE branch since the profile shows we are always in the IF branch 2) break when the for loop has too few or too many iterations after completion 3) break when we reach the end of function C after significantly more, or significantly less, than 120 seconds.

One of skill in the art will appreciate that instead of requiring conjecture as to the cause of a software error, the present invention preemptively breaks at specific lines or regions of code due to significant differences in profiled behavior. Consequently, a developer could be directed immediately to Function C( ) to evaluate whether the detected deviation in behavior corresponds to a software error.

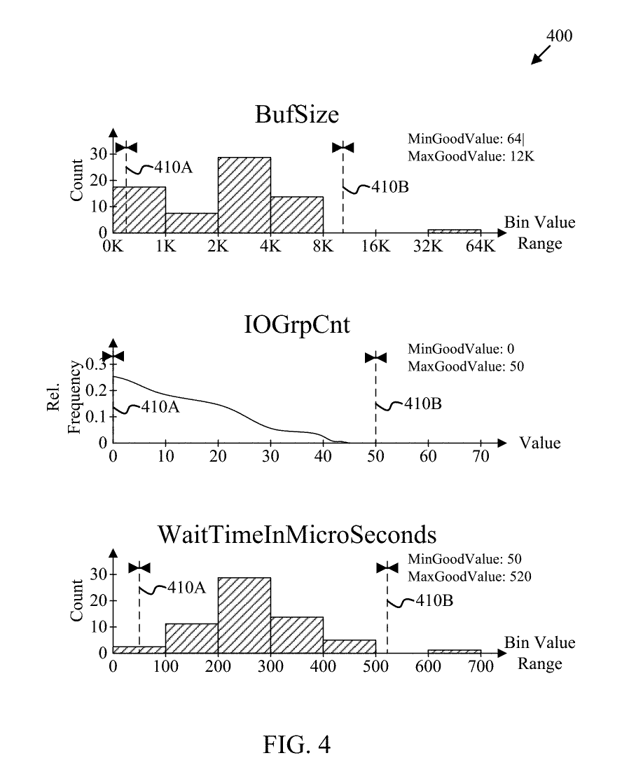

FIG. 4 is a user interface diagram depicting one example of a parameter limits interface 400 in accordance with at least one embodiment of the present invention. As depicted, the parameter limits interface 400 displays historical information such as statistical information on specific parameters or variables and enables a user such as a tester or developer to specify acceptability limits 410 on each displayed parameter. The acceptability limits may include a lower limit 410A and an upper limit 410B. In some embodiments, the acceptability limits 410 are automatically determined from statistical data for the parameter. However, the parameter limits interface 400 enables a user to manually override any default or automatic settings. The acceptability limits may be used by a monitoring process to trigger breakpoints.

One of skill in the art will appreciate that the embodiments disclosed herein enable improved and automatic detection of software errors. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

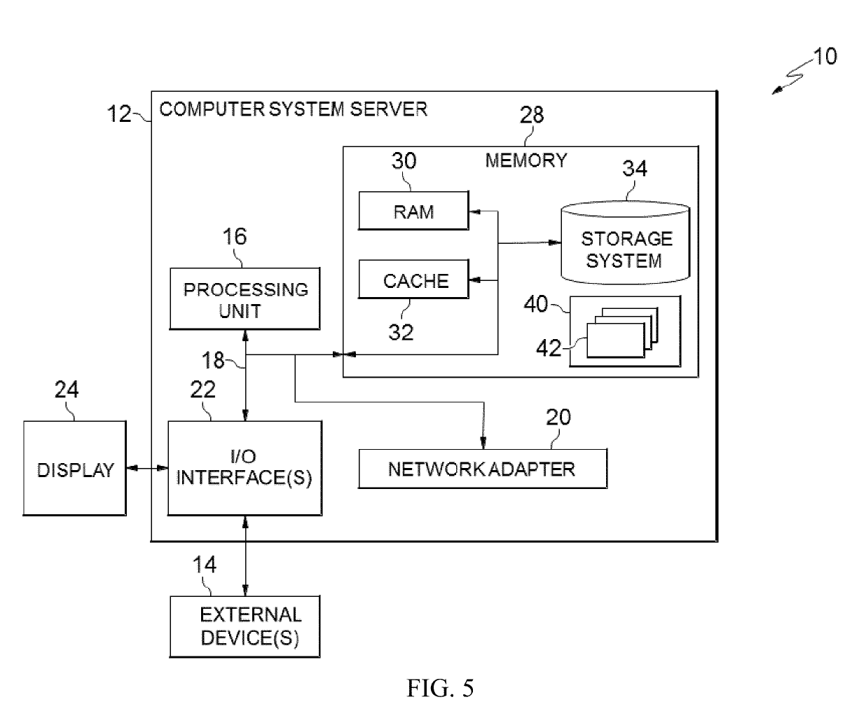

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

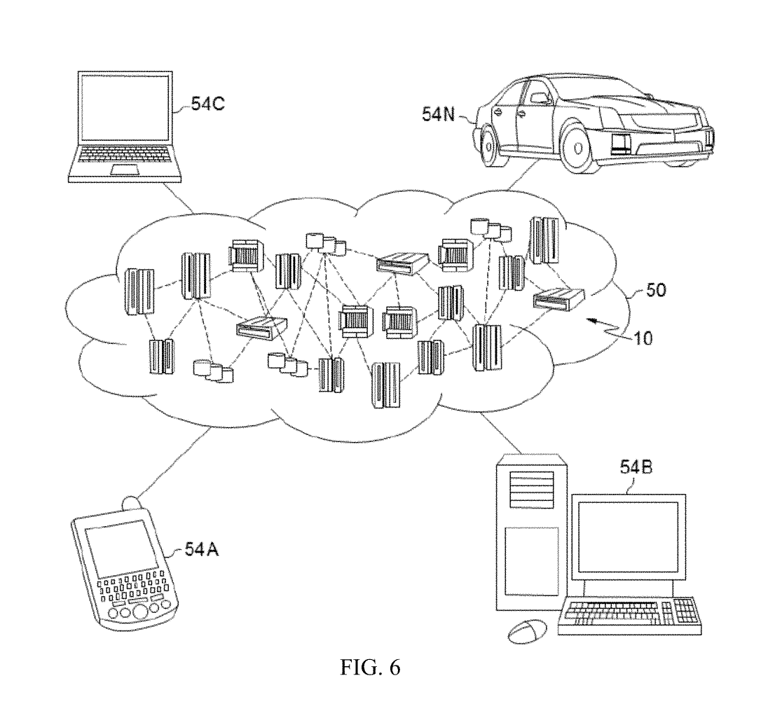

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

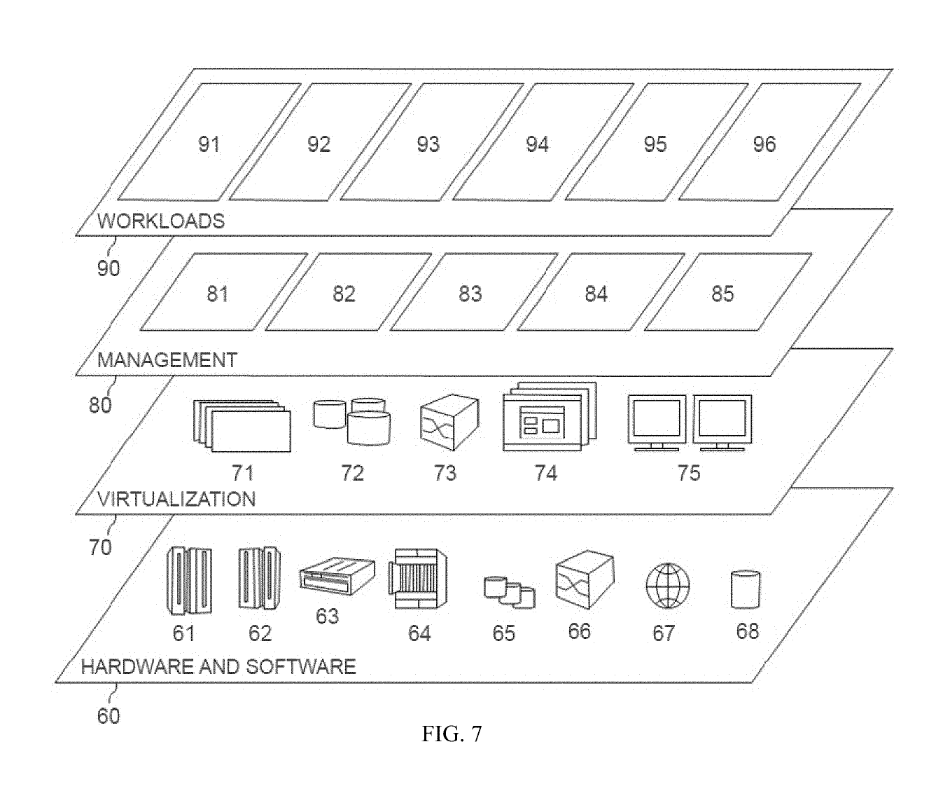

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and deployed enterprise application 96.

It should be noted that this description is not intended to limit the invention. On the contrary, the embodiments presented are intended to cover some of the alternatives, modifications, and equivalents, which are included in the spirit and scope of the invention as defined by the appended claims. Further, in the detailed description of the disclosed embodiments, numerous specific details are set forth in order to provide a comprehensive understanding of the claimed invention. However, one skilled in the art would understand that various embodiments may be practiced without such specific details.

Although the features and elements of the embodiments disclosed herein are described in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for improving detection in software errors, executed by one or more processors, the method comprising:
repeatedly collecting, by the one or more processors, execution information for a code unit to produce collected execution information for the code unit, wherein repeatedly collecting execution information comprises setting a breakpoint within the code unit, wherein the code unit is a block of code statements, wherein the block of code statements comprises a loop control statement and a branch statement, wherein the collected execution information comprises an execution duration, an execution count, a branching target, and a branching source;
monitoring, by the one or more processors, one or more breakpoints, wherein the one or more breakpoints comprise: a breakpoint at a beginning of a loop, a breakpoint at an end of a function, and a breakpoint in the code unit;
generating, by the one or more processors, an execution profile for the code unit based on the collected execution information and monitoring of the one or more breakpoints;
comparing, by one or more processors, current execution information for the code unit with the execution profile;
breaking, by the one or more processors, at a specific line of code based on the differences in the current execution information and the execution profile.
informing, by one or more processors, a user if the current execution information does not conform to the execution profile based on the user specified preferences of notification, and thresholds, and inform the user at one or more of the breakpoints due to outlier behavior, wherein outlier behavior at the one or more breakpoints comprises: break when the code unit is consistently in the IF branch, break when the loop has too few or too many iterations after completion, or break when the end of the function is significantly more, or significantly less, than 120 seconds, wherein informing a user comprises suspending execution at a statement corresponding to the code unit; and
updating, by one or more processors, the execution profile for the code unit based on the collected execution information and the outlier behavior of the one or more breakpoints.
